(19) United States
(12) Patent Application Publication
(10) Pub. No.: US 2020/0273044 A1
(43) Pub. Date: Aug. 27, 2020

(54) Shared Customer Relationship Management (CRM) System and Method using Event Based Normalization

(71) Applicant: MetaCX, Inc., Indianapolis, IN (US)

(72) Inventors: Scott McCorkle, Indianapolis, IN (US); David Duke, Indianapolis, IN (US); Jake Miller, Indianapolis, IN (US); Jason Schmidt, Indianapolis, IN (US)

(21) Appl. No.: 16/803,991

(22) Filed: Feb. 27, 2020

Related U.S. Application Data
(60) Provisional application No. 62/811,397, filed on Feb. 27, 2019.

(51) Int. Cl. G06Q 30/00; G06Q 50/28; G06Q 10/06; G06F 16/9535

(52) U.S. Cl. CPC G06Q 30/016; G06F 16/9535; G06Q 10/067; G06Q 50/28

(57) ABSTRACT

The present disclosure discloses a system and method for creating a shared Customer Relations Management (CRM) system using normalized identities. In at least one embodiment of the present disclosure, a method for creating a shared Customer Relations Management (CRM) system includes: creating a Software as a Service (SaaS) CRM; creating a shared space in the SaaS CRM; enabling both business and customer to access the SaaS CRM; enabling both the business and customer to access the shared space in the SaaS CRM; defining desired outcomes for both the business and customer in the SaaS CRM; and measuring the success of the desired outcomes of the business and customer in the SaaS CRM.

### PRIORITY

This application claims priority to U.S. Provisional Patent Application No. 62/811,397, filed Feb. 27, 2019, which application is incorporated in its entirety by reference, herein.

### TECHNICAL FIELD

The present invention relates generally to customer relationship management (CRM), and more specifically, to a new and improved system and method for customer relationship management in which the customer participates in how the relationship is managed and is able to manage their vendors through the system.

### BACKGROUND

Customer relationship management (CRM) systems and solutions are well known and utilized by businesses of varying sizes to manage interactions with current and potential customers. Examples of popular CRM systems include Salesforce, SAP CRM, Oracle CRM, Microsoft Dynamics CRM, and Adobe Marketing Cloud. However, current CRM systems rely on the business utilizing them to define and manage the expectations of their customers with no direct input from the customer. The one-way model used by traditional CRM systems focuses primarily on the business using the CRM, not on the relationship between the business and the customer. Industry analysts have estimated that as many as 70% of CRM implementations fail.

For example, referring now to FIG. 1, it is shown a traditional CRM implementation 100. In the traditional CRM implementation 100, the SaaS supplier 102 is provider of SaaS product 104. The SaaS supplier 102 may operate supplier CRM 102B for the management of customer relationships. The SaaS supplier 102 has certain desired outcomes 102A for the running of the SaaS supplier 102's business, and which desired outcomes 102A are independently managed by the SaaS supplier 102 without SaaS buyer 108. By way of an example, a desired outcome 102A of the SaaS supplier 102 may be that SaaS buyer 108 purchase a certain number of licenses for the use for the SaaS product 104. Continuing with this example, the SaaS buyer 108 may purchase the SaaS product 104 and use/access the same via Internet 106. The SaaS supplier 102 may manage the relationship with SaaS buyer 108 via the supplier CRM 102B. As with the case with the SaaS supplier 102, the SaaS buyer 108 has desired outcomes 108A. By way of an example, the SaaS buyer 108 may have a desired outcome 108A of minimizing spend on the SaaS product 104, or better understand how employees at SaaS buyer 108 integrate SaaS product 104 with SaaS product 110 (by different SaaS supplier 110). In any case, the desired outcomes 102A and desired outcomes 108A are independent of each other, and only serve to benefit the respective parties (i.e. SaaS supplier 102 and SaaS buyer 108). However, SaaS buyer 102 and SaaS supplier 108 may have mutually beneficial desired outcomes. For example, SaaS supplier 108 may be able to offer a pricing scheme for features that maximizes SaaS supplier 102's sales, but also provide better adoption strategies to SaaS buyer 108, and also use of the SaaS product 104 by SaaS buyer 108, and its employees. Similarly, SaaS buyer 108 may also obtain SaaS product 112 from SaaS supplier 110, and SaaS supplier 110 may have its desired outcomes 110A, which is also managed via supplier CRM 110B. In such an example, the desired outcomes 110A are independent from the buyer desired outcomes 108A. Continuing with this example, the desired outcomes of SaaS supplier 102, SaaS buyer 108, and SaaS supplier 110 in such cases would be determined by each respective party that is defining their own desired outcomes.

Continuing with the traditional example, each of the SaaS supplier 102, SaaS buyer 108, and SaaS supplier 110 may be identified as disparate entities, in a non-normalized manner, in each other's management of the relationship. For example, SaaS buyer 108 may have purchased multiple SaaS products from SaaS supplier 110 (e.g. SaaS product 112), but SaaS buyer 108's management of such procurement from SaaS supplier 110 may not be consistent. As a result, SaaS buyer 108 may be engaged in multiple redundant purchases from SaaS supplier 110. It will be well appreciated that this leads to an inefficient system with many desired outcomes going unaccomplished.

Therefore, there is a need for an improved shared customer relationship management (crm) system and method using event based normalization, in which the customer participates in how the relationship is managed with the supplier.

### SUMMARY

The present disclosure relates to a system and method for shared customer relationship management (CRM) using event based normalization.

In at least one embodiment of the present disclosure, the method includes configuring at least one core object for a supplier, a buyer, and a supplier platform, configuring a plurality of objects representative of a identifier for the each supplier and buyer, receiving an event data from at least one supplier, buyer, or supplier platform, at an event queue, and normalizing an identity for the each of the supplier, buyer.

In at least one embodiment of the present disclosure, the method includes normalizing a field name at a field normalizer for the event data, filtering events based at least in part on a desired outcome of the each of a supplier, a buyer, creating an object model timeline based on a processed event from the at least one of a supplier, a buyer, or a supplier platform, at an event queue, updating the at least one core object or plurality of core objects based at least in part on the filtered events.

In at least one embodiment of the present disclosure, the method includes assessing the desired outcome for the each supplier and buyer, based at least in part on a business goal for the each of the supplier and buyer, determining a state for the desired outcome.

In at least one embodiment of the present disclosure, the method includes configuring at least one core object for a supplier, a buyer, and a supplier platform includes a definition of a metric.

In at least one embodiment of the present disclosure, the method includes configuring a plurality of objects is selected form a group consisting of a customer, a vendor, a person, a contract, and a desired outcome.

In at least one embodiment of the present disclosure, the method includes event data that is received at an event queue and ingested into an immutable log.

In at least one embodiment of the present disclosure, the method includes filtering events based at least in part on a desired outcome of the each of a supplier and a buyer includes determining declarative events, based at least in part on a user defined criteria.

### BRIEF DESCRIPTION OF THE DRAWINGS

FIG. 1 shows a schematic drawing of the relationship of a traditional CRM system and the current relationship between business and customer, CRM and digital product.

FIG. 2A shows a schematic drawing of a system where the CRM and digital product are merged and used by both the business and customer, according to at least one embodiment of the present disclosure.

FIG. 2B shows a schematic drawing of the components of a shared CRM 250 according to at least one embodiment of the present disclosure.

FIG. 2C shows a schematic drawing of the components of a subscription worker 274 according to at least one embodiment of the present disclosure.

FIG. 3 shows a schematic drawing of a system where the CRM and digital product are merged and used by both a plurality of businesses and a plurality of customers, according to at least one embodiment of the present disclosure.

FIG. 4 shows an exemplary embodiment of a system where the CRM and digital product are merged and used by a business and customer, according to at least one embodiment of the present disclosure.

FIG. 5A shows an exemplary embodiment of a desired outcome according to at least one embodiment of the present disclosure.

FIG. 5B shows an exemplary embodiment of a shared outcome management according to at least one embodiment of the present disclosure.

FIG. 6 shows a method for shared CRM using event based normalization according to at least one embodiment of the present disclosure.

FIG. 7 shows a method for time zone architecture according to at least one embodiment of the present disclosure.

FIG. 7A shows an exemplary embodiment of a time zone architecture according to at least one embodiment of the present disclosure.

FIG. 7B shows an exemplary embodiment of a time zone architecture according to at least one embodiment of the present disclosure.

FIG. 8A shows an exemplary embodiment of a business network according to at least one embodiment of the present disclosure.

FIG. 8B shows an exemplary embodiment of a shared business network according to at least one embodiment of the present disclosure.

FIG. 8C shows an exemplary embodiment of a shared business network according to at least one embodiment of the present disclosure.

FIG. 8D shows an exemplary embodiment of a shared business network according to at least one embodiment of the present disclosure.

FIG. 8E shows an exemplary embodiment of a shared business network according to at least one embodiment of the present disclosure.

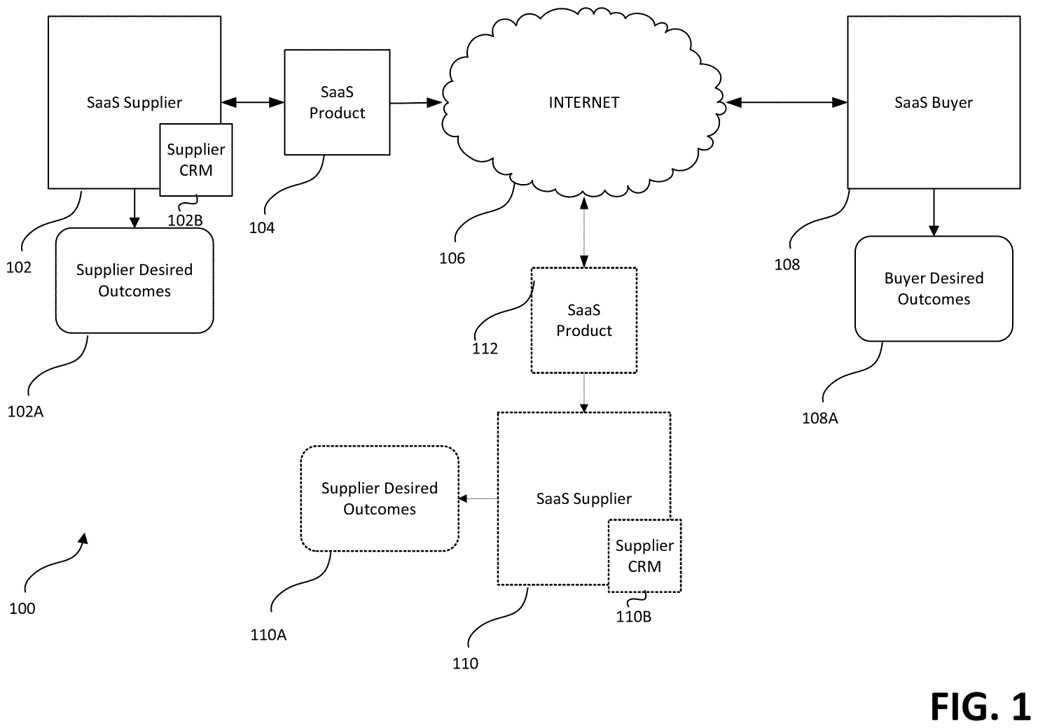

### DETAILED DESCRIPTION

Reference will now be made in detail to the preferred embodiments of the present disclosure, examples of which are illustrated in the accompanying drawings. Additional features and advantages of the disclosure will be set forth in the description that follows, and will be apparent from the description, or may be learned by practice of the disclosure. It is to be understood that both the foregoing general description and the following detailed description are exemplary and explanatory and are intended to provide further explanation of the disclosure as claimed.

This detailed description is presented in terms of programs, data structures or procedures. The software programs implemented may be written in any programming and markup language(s)—interpreted, compiled, or otherwise, as further disclosed herein. These languages may include, but are not limited to, PHP, ASP.net, HTML, HTML5, Ruby, Perl, Java, Python, C++, C#, JavaScript, and/or the Go programming language. It should be appreciated, of course, that one of skill in the art will appreciate that other languages may be used instead, or in combination with the foregoing and that web and/or mobile application frameworks may also be used, such as, for example, Ruby on Rails, Node.js, Zend, Symfony, Revel, Django, Struts, Spring, Play, Jo, Twitter Bootstrap and others. It should further be appreciated that the systems and methods disclosed herein may be embodied in software-as-a-service available over a computer network, such as, for example, the Internet. Further, the present disclosure may enable web services, application programming interfaces and/or service-oriented architecture through one or more application programming interfaces or otherwise, as further disclosed herein.

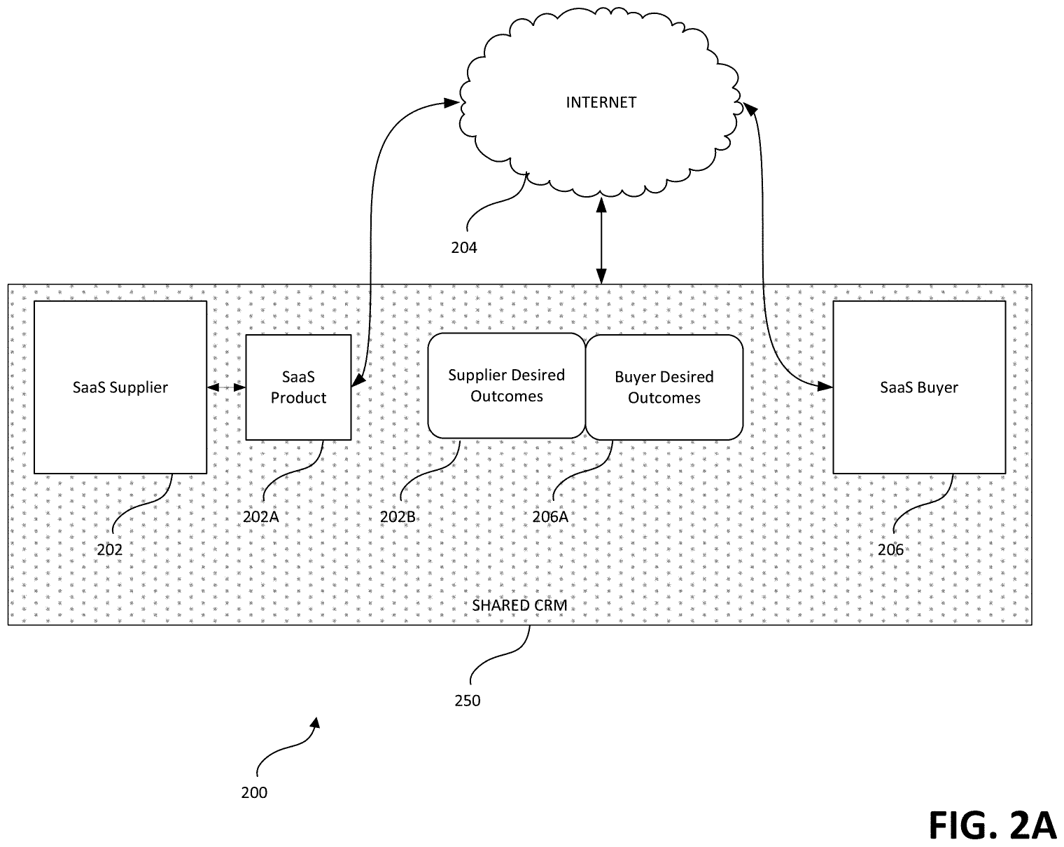

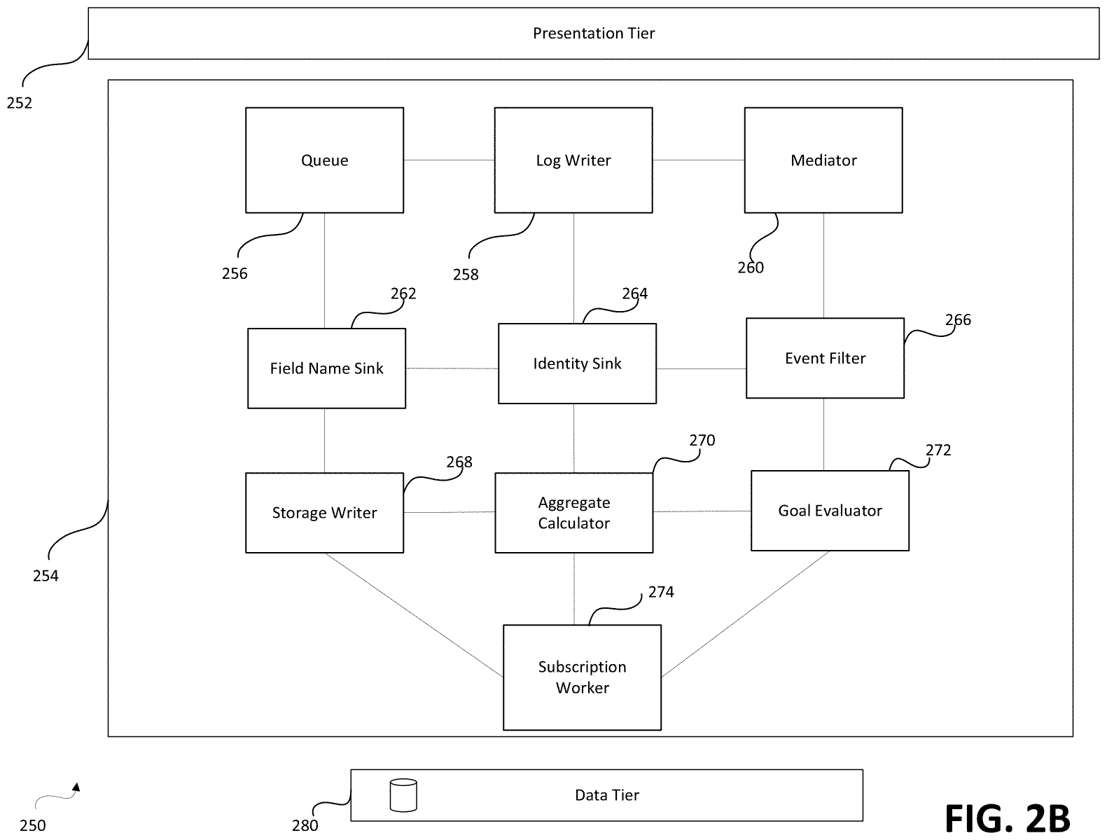

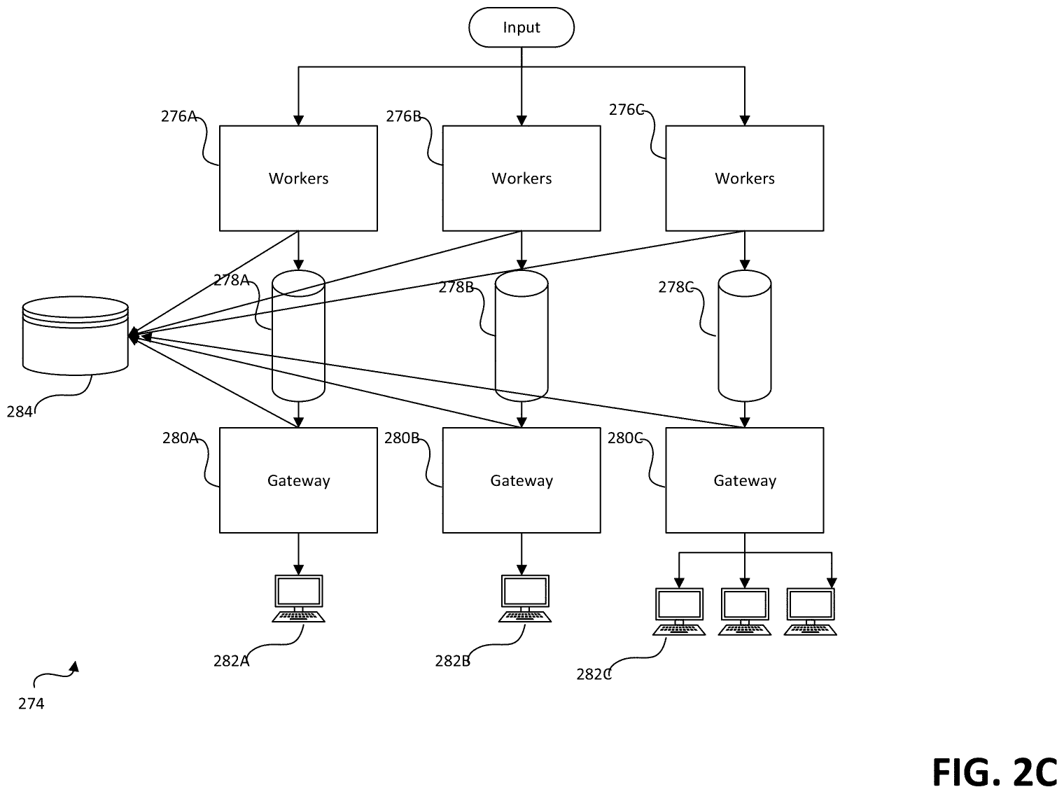

Referring now to FIG. 2A, it is shown a schematic drawing of a system 200 where the CRM and digital product are merged and used by both the business and customer, according to at least one embodiment of the present disclosure. In at least one embodiment of present disclosure, the system 200 includes a SaaS supplier 202, a SaaS product 202A, supplier desired outcomes 202B, a network 204, a SaaS buyer 206, buyer desired outcomes 206A, and a shared CRM 250.

In at least one embodiment of the present disclosure, the each of the components of the system 200 may be configured to transmit information to and generally interact with each other via a web service and/or application programming interface (API) infrastructure housed on CRM system 250 over network 204.

In at least one embodiment of the present disclosure, the SaaS supplier 202 is an entity that provides service subscriptions to its clients (e.g. business enterprises or customers of different size). For clarity, SaaS supplier 202 may also be referred to as “service providers,” and it shall be understood that both terms may be used interchangeably. Additionally, the SaaS supplier 202 can provide subscriptions to applications and services (e.g. SaaS product 202A) located on hosting servers (not shown). The SaaS supplier 202 can further host services that are subscribed to by customers. SaaS supplier 202 may be software development companies that develop, support and run services (usually on their own cloud infrastructures). The SaaS supplier 202 also sells and provides subscriptions to their services (e.g. SaaS product 202A). It will be appreciated that the SaaS supplier 202 may provide an application programming interface (API) for each of its services. The API may include a set of classes, procedures, functions, structures and constants provided by the SaaS supplier 202 for use in or integration with external applications. The SaaS supplier 202 may include a plurality of software services, such as, for example, Dropbox®, Amazon® Web Services, and Office 365®.

In at least one embodiment of the present disclosure, the SaaS supplier 202 and SaaS buyer 206 may each have desired outcomes respectively (i.e. supplier desired outcomes 202B and buyer desired outcomes 206A). The each of the desired outcomes may be business goals, according to at least one embodiment of the present disclosure. It will be appreciated that the desired outcomes of the each SaaS supplier 202 and SaaS buyer 206 are now jointly collaborative in the shared CRM 250, as further disclosed herein.

In at least one embodiment of the present disclosure, the network 204 may include one of the different types of networks, such as, for example, Internet, intranet, local area network (LAN), wide area network (WAN), a metropolitan area network (MAN), a telephone network (such as the Public Switched Telephone Network), the internet, an optical fiber (or fiber optic)-based network, a cable television network, a satellite television network, or a combination of networks, and the like. The network 204 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. It will be further appreciated that the network 204 may include one or more data processing and/or data transfer devices, including routers, bridges, servers, computing devices, storage devices, a modem, a switch, a firewall, a network interface card (NIC), a hub, a bridge, a proxy server, an optical add-drop multiplexer (OADM), or some other type of device that processes and/or transfers data, as would be well known to one having ordinary skills in the art. It should be appreciated that in various other embodiments, various other configurations are possible. Other computer networks, such as Ethernet networks, cable-based networks, and satellite communications networks, well known to one having ordinary skills in the art, and/or any combination of networks are contemplated to be within the scope of the disclosure.

In at least one embodiment of the present disclosure, the SaaS buyer 206 may be an entity that is seeking to procure SaaS services from SaaS supplier 202. It will be appreciated that SaaS buyer 206 may maintain and operate, or further comprise such software, hardware, and componentry as would occur to one of skill in the art, such as, for example, microprocessors, memory systems, input/output devices, device controllers, display systems, and the like, which collectively are operable to perform the functions allocated to the SaaS buyer 206 in accordance with the present disclosure.

In at least one embodiment of the present disclosure, shared CRM 250 includes such software, hardware, and componentry as would occur to one of skill in the art, such as, for example, microprocessors, memory systems, input/output devices, device controllers, display systems, and the like, which collectively are operable to perform the functions allocated to shared CRM 250 in accordance with the present disclosure.

In at least one embodiment of the present disclosure, the shared CRM 250 utilizes Web3.0 principles including, but not limited to: blockchain; peer2peer (P2P); and distributed architecture. The use of Web 3.0 principles enables a modern business-to-business (B2B) network which provides equal value to suppliers and buyers.

It will be appreciated that shared CRM 250 is integrated with the SaaS product 202A to facilitate capturing of events and assessing progress toward meeting desired outcomes (i.e. business goals) of the each of the SaaS supplier 202 and SaaS buyer 206, as further disclosed herein. It will be further appreciated that the integration of shared CRM 250 with SaaS product 202A which is being purchased allows: (1) SaaS supplier 202 to determine if the SaaS buyer 206 is achieving the right milestones; (2) the SaaS supplier 202 to determine if the SaaS supplier 202 is achieving the SaaS buyer 206's desired outcomes; and (3) the SaaS supplier 202 and the SaaS buyer 206 to interact and collaborate via shared CRM 250 to achieve both the product milestones and desired outcomes, as further disclosed herein. It will be further appreciated that the integration allows shared CRM 250 to become the system of record.

It will be appreciated that events in the system 200 can seamlessly transmitted to shared CRM 250, and ingested by shared CRM 250, as further disclosed herein. It will be further appreciated that every activity in the system 200 is an event for ingestion into the shared CRM 250, as further disclosed herein. By way of an example, if SaaS buyer 206's employee logs into SaaS product 202A, the login activity is an event activity.

In at least one embodiment of the present disclosure, the shared CRM 250 is configured to create core objects for each feature within the shared CRM 250, based on at least a characteristic of the entities and the business. By way of an example, the shared CRM 250 may be configured to create core objects based on the SaaS supplier 202, a SaaS product 202A, supplier desired outcomes 202B, a SaaS buyer 206, buyer desired outcomes 206A, and any activities within the system 200, as further disclosed herein. It will be appreciated that defining core objects in the shared CRM 250 allows for efficient sharing of any events in the system 200, and determining declarative events that constitute business value, as further disclosed herein.

By way of an example upon updating a core object indicative of the opening of the new retail store, the shared CRM 250 executes a rules engine to identify applicable, permissive and/or restricted data sharing requirements, according at least one embodiment of the present disclosure. It will be appreciated that the applicable rules define which ‘events’ can be shared and with which parties/entities of the shared CRM 250.

It will also be appreciated that the shared CRM 250 is configured to allow for shared ownership of core system objects, such as, for example, an outcome. It will be further appreciated that the shared CRM 250 is configured to allow a customizable definition of core system objects based on at least a characteristic of a business (e.g. the SaaS buyer 206). By way of an example, a customer may be treated as an “account” in a particular business model. Continuing with this example, the “account” may be defined as a core system object describing the business in at least one embodiment of the shared CRM 250. It will be appreciated that an update to the business will generate an ‘event’ that updates the core object within the shared CRM 250, as further disclosed herein. By way of another example, a customer retailer, operating the shared CRM 250, may operate a plurality of retail stores as its ongoing business. The foregoing customer retailer's current business may be set as a core object in at least one embodiment of the shared CRM 250. Any updates or changes to the customer retailer, will generate an event in the shared CRM 250. Continuing with this example, the customer retailer may open a new retail store in its ongoing business. In at least one embodiment of the present disclosure, this new opening of the retail store will generate an event to update the core object that defines the customer retailer, the update indicative of the customer retailer opening the new store. It will be further appreciated that the core object may then be shared (e.g. via an event) to other entities, such as, for example, a vendor of the customer retailer, which vendor may need to know about the opening of the new retail store.

Referring now to FIG. 2B, it is shown a drawing of the components of a shared CRM 250 according to at least one embodiment of the present disclosure. In at least one embodiment of the present disclosure, shared CRM 250 includes a presentation tier 252, an application processing tier 254, and a data tier 280.

In at least one embodiment of the present disclosure, the presentation tier 252 includes such software, hardware, and componentry as would occur to one of skill in the art, such as, for example, microprocessors, memory systems, input/output devices, device controllers, display systems, and the like, which collectively are operable to perform the functions allocated to the presentation tier 252 in accordance with the present disclosure.

In at least one embodiment of the present disclosure, the application processing tier 254 includes a starting step 255, queue 256, log writer 258, mediator 260, field name sink 262, identity sink 264, event filter 266, storage writer 268, aggregate calculator 270, goal evaluator 272, and subscription worker 274.

In at least one embodiment of the present disclosure, the data tier 280 is configured to store information generated by shared CRM 250 and/or retrieved from one or more information sources. In at least one embodiment of the present disclosure, data tier 280 can be “associated with” a server. Data tier 280 can also be “associated with” shared CRM 250 where data tier 280 resides on a server or computing device remote from shared CRM 250, provided that the remote server or computing device is capable of bi-directional data transfer with shared CRM 250, such as, for example, in Amazon AWS, Rackspace, or other virtual infrastructure, or any business network. In at least one embodiment of the present disclosure, the remote server or computing device upon which data tier 280 resides is electronically connected to shared CRM 250 such that the remote server or computing device is capable of continuous bi-directional data transfer with shared CRM 250.

For purposes of clarity, data tier 280 is shown in FIG. 2B, and referred to herein as a single tier or database. It will be appreciated by those of ordinary skill in the art that data tier 280 may comprise a plurality of tiers or databases connected by software systems of a type well known in the art, which collectively are operable to perform the functions delegated to data tier 280 according to the present disclosure. Data tier 280 may also be part of distributed data architecture, such as, for example, a Hadoop architecture, for big data services. Data tier 280 may comprise relational database architecture, noSQL, OLAP, or other database architecture of a type known in the database art. Data tier 280 may comprise one of many well-known database management systems, such as, for example, MICROSOFT's SQL Server, MICROSOFT's ACCESS, MongoDB, Redis. Hadoop, BigTable, or IBM's DB2 database management systems, or the database management systems available from ORACLE or SYBASE. Data tier 280 retrievably stores information that is communicated to data tier 280 from application processing tier 254, or any other components of system 200.

Referring now to FIG. 2C, it is shown a schematic drawing of the components of the subscription worker 274, according to at least one embodiment of the present disclosure. The subscription worker 274 includes a plurality of workers (i.e. worker 276A, 276B, 276C), a plurality of queues (queue 278A, 278B, 278C), a plurality of gateways (280A, 280B, 280C), a plurality of end user devices (device 282A, 282B, 282C), and subscription list 284.

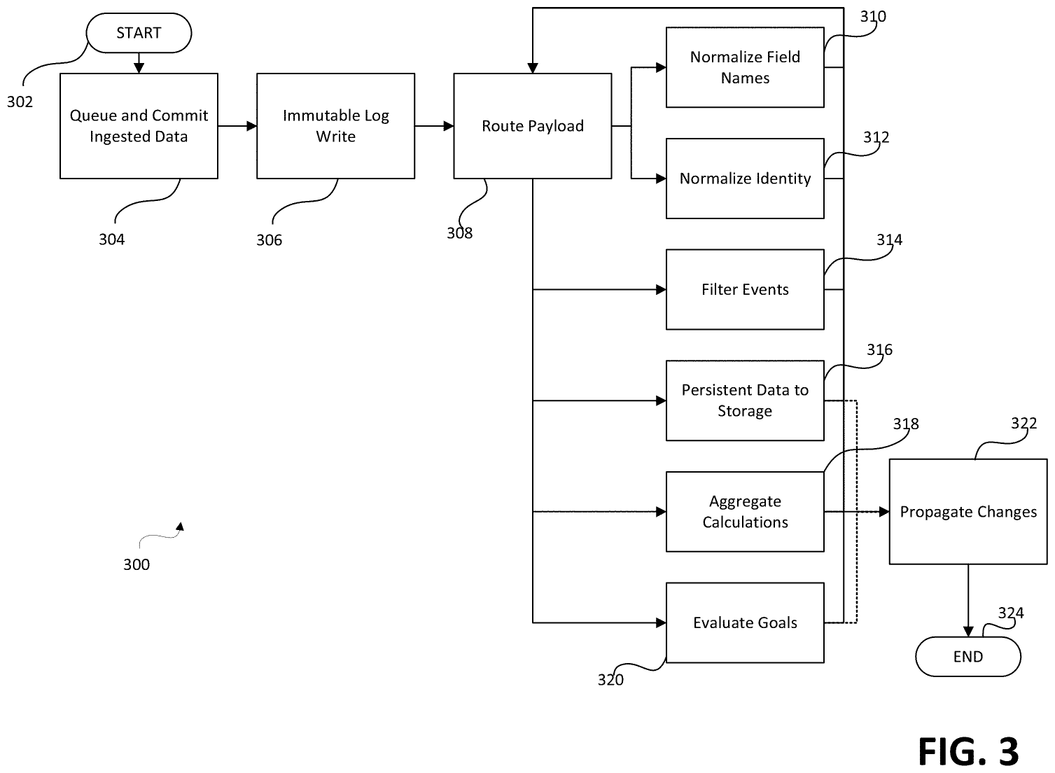

Referring now to FIG. 3, it is shown a method 300 for shared customer relationship management using event based normalization, according to at least one embodiment of the present disclosure. The method 300 begins processing events at starting step 302. It will be appreciated that the method 300 is invoked any time an event occurs within the system 200, and is transmitted to the shared CRM 250.

In at least one embodiment of the present disclosure, the queue 256 is configured to receive raw event data at step 304. It will be appreciated that the raw event data may obtained from any source, in addition to any components of system 200. By way of an example, the queue 256 may receive raw event data from SaaS product 202A, or SaaS supplier 202. It will be appreciated that queue 256 may also receive raw event data from other sources (not shown), by way of an API, data exchange, or any other methods well known to one having ordinary skill in the arts. By way of an example, if the event is indicative of an update, the application processing tier 254 records the update and saves the corresponding record. It will be appreciated that the foregoing event based operations of shared CRM 250 is powerful because it allows for acting on CRUD actions in the rules engine just like any external event. It will be further appreciated that any object state change is also an event. Upon receiving event data, the method 300 proceeds to step 306.

In at least one embodiment of the present disclosure, the method 300 is configured to write the raw event data to an immutable log (not shown) via the log writer 258. It will be appreciated that the immutable log is additive and raw event data cannot be removed from the event log. It will be further appreciated that the immutable log is tamper-resistant and provides a recording of all events that occurred in the system 200. The method 300 then proceeds to step 308.

In at least one embodiment of the present disclosure, the mediator 260 is configured to route the raw data payloads (or other types of payloads as further disclosed herein) at step 308. In at least one embodiment of the present disclosure, the mediator 260 is configured to route the payload for each raw event based on the prior processing step, and a plurality of mappings based on a rules engine, configured as further disclosed herein. In at least one embodiment of the present disclosure, the mediator 260 is configured to analyze the payload and determine additional work functions to be performed on the payload. It will be appreciated that the mediator 260 may be configured to identify events of business value, and determine the declarative nature of events, and further filter irrelevant events, as further disclosed herein.

It will be further appreciated that the mediator 260 is a multiplexer-based router of event data. In at least one embodiment of the present disclosure, the mediator 260 may include a plurality of sub-systems for the analysis and processing of event data, as further disclosed herein. It will be appreciated that the mediator 260 is configure to determine the next processing step of the raw event data, in a stateless manner (i.e. without recording the “state” of the raw event data). It will be appreciated that after each processing step in the method 300, the method 300 subsequently returns to mediator 260 for further determining of applicable processing steps to the event data, as further disclosed herein.

After the mediator 260 has determined the next appropriate processing step, the method 300 may proceeds to step 310, in at least one embodiment of the present disclosure. The raw event data is processed to normalize field names at step 310, using the field name sink 262. In at least one embodiment of the present disclosure, the field name sink 262 is configured to normalize field names in the raw event data to create an object model based on the raw event data. By way of an example, the raw event data from SaaS supplier 202 may use “fname” to identify the first name of an individual. Similarly, raw event data from SaaS buyer 206 may use “full_nm” to identify the first name of an individual. It will be appreciated that when raw event data from SaaS supplier 202 and SaaS buyer 206 is transmitted to field name sink 262, the “fname” and “full_nm” are normalized so that both sources of raw event data are processed to determined that the raw event data contains the ‘first name.’ It will be appreciated that the field name sink 262 may be configured at the onset when raw event data sources are established for connectivity to the shared CRM 250.

In at least one embodiment of the present disclosure, the method 300 then proceeds to step 312 where identity sink 264 normalizes the identities in the raw event data. Continuing with the example above, SaaS supplier 202 may transmit “fname” as “Joe Smith” and SaaS buyer 206 may transmit “full nm” as “J. Smith.” It will be appreciated that the identity sink 264 is configured to normalize both names as “Joe Smith” in the event data.

It will be appreciated that identity normalization is occurs for every discrete event. In at least one embodiment of the present disclosure, each event may have one or more metakeys associated with the event data, which metakeys are resolved as further disclosed herein. In at least one embodiment of the present disclosure, identity normalization may not occur. In at least one embodiment of the present disclosure, the method 600 continues to step 618 where metakeys are resolved. It will be appreciated that the shared CRM 250 is further configured to use meta data of the event or the contextual data of the transaction underlying the event. By way of an example, a customer of the shared CRM 250 may engage in an email marketing campaign. In at least one embodiment of the present disclosure, the shared CRM 250 is configured to capture meta data associated with the email marketing campaign event, such as, for example, how many people received emails, what the open rate of the emails were, and the like. It will be appreciated that the shared CRM 250 is configured to assess and compare events. Continuing with the example above, the shared CRM 250 may assess the success of the email marketing campaign by comparing any meta data with meta data obtained from previous events (i.e. another email marketing campaign).

It will be appreciated that identity normalization can be performed by identity sink 264 for any object identifier associated with the system 200. For example, a company, a person, a device, can be normalized. It will be further appreciated that identity normalization allows the shared CRM 250 to have dimensionality for the event data, throughout the shared CRM 250. By way of an example, normalized identities allow the shared CRM 250 to correlate dissimilar sources of event data regardless of the source.

In at least one embodiment of the present disclosure, the application processing tier 254 is configured to normalize identities at the time of raw event data ingestion. It will be appreciated that normalizing identities at the time of raw data ingestion (i.e. in real time) allows the shard CRM 250 to dimension the event data, and associate multiple different source systems, as further disclosed herein. Upon normalizing data, the method 300 may then proceed to step 314.

In at least one embodiment of the present disclosure, the method 300 filters events at step 314, using the event filter 266. The event filter 266 is configured to be declarative at the time an event source is configured to transmit data to the shared CRM 250. In at least one embodiment of the present disclosure, the event filter 266 may be configured to filter for events of particular business value. In at least one embodiment of the present disclosure, shared CRM 250 is designed to utilize the customer success (CS) business methodology at step 314 to ensure that customers (e.g. buyer 406) achieve their desired outcomes while using the product or service of the supplier (e.g. supplier 402). The CS methodology allows suppliers to ensure renewal of business agreements, find growth opportunities, and create advocates from buyers.

In at least one embodiment of the present disclosure, shared CRM 250 is designed to utilize the business outcome management methodology (BOM) by enabling suppliers and customers to collaborate together through the stages of value achievement across the customer lifecycle. It will be appreciated that the phases of the BOM are: Discover, Document, Deliver, Determine, and Demonstrate. Specifically, the phases of the BOM are: (1) Define the business outcomes that your customer needs to achieve (Discover); (2) Outline the path the customer needs to take to achieve the outcomes (Document); (3) Work with your customer through the process of leveraging your products and services to achieve the outcome(s) (Deliver); (4) Measure progress to determine if your customers are doing what it takes to accomplish their outcomes (Determine); and (5) Tell the story of the work that was executed (or not) to achieve the outcome(s) (Demonstrate).

In at least one embodiment of the present disclosure, the shared CRM 250 implementation for a given buyer occurs in three phases: (1) Develop an outcome strategy with the Business Outcome Management (BOM) methodology (Outcome Strategy); (2) Identity and measure activities that all buyers should achieve if they are to be successful (Success Milestones); and (3) Provide a clear path, through use of a shared space, to operationalizing value delivery to a supplier's buyers (Business Outcome Management). It will be appreciated that the method 300 configured to generate an event and pass the same through the application processing tier 254, if or when a buyer achieves or stops achieving an outcome, as further disclosed herein.

In at least one embodiment of the present disclosure, the shared CRM system 250 uses core data objects to measure and track desired outcomes. These core data objects may be shared between the business and customer and can be owned by either the business or customer. In at least one embodiment of the present disclosure, the shared CRM system uses application events, metrics, and project tasks to identify and measure activities that all customers of a business should achieve to meet desired outcomes.

The method 300 may then proceed to step 316.

In at least one embodiment of the present disclosure, the method 300 writes data to persistent storage at step 316, via storage writer 268. It will be appreciated that persistent storage may be the data tier 280. In at least one embodiment of the present disclosure, storage writer 268 is configured to write updates to persistent storage based on a timeline. By way of an example, the storage writer 268 is configured to write point-in-time events on a user defined object model timeline. By way of an example, at time 0, a user may have logged in and set their user interface (UI) preferences; at a subsequent time 10, the same user may have logged in and changed their UI preferences. It will be appreciated that the storage writer 268 is configured to store both events on an object model timeline. It will be further appreciated that storage the event data as such allows for the tracking of the timestamp of the event occurrence, as opposed to the time the shared CRM 250 processes the event. For example, an event that occurred may not be transmitted to the shared CRM 250 until a week later. In this example then, the storage writer 268 is configured to store the event to persistent storage based on the object model timeline of when the event occurred (i.e. a week ago), as opposed to when the shared CRM 250 received the event (i.e. at present time). It will be further appreciated that storing events on an object model timeline allows for metrics and milestones applicable to business goals to be readily determined, as further disclosed herein.

In at least one embodiment of the present disclosure, the method 300 may then proceed to step 318 where aggregate calculations are performed via aggregate calculator 270. In at least one embodiment of the present disclosure, the aggregate calculator 270 may be configured based on pre-defined buckets of time units. In at least one embodiment of the present disclosure, the aggregate calculator 270 is configured to aggregate the object model timeline events into buckets based on seconds, minute, hour, day, month, year, and all-time. It will be appreciated that the aggregate calculator 270 may be configured for any unit of time bucket, such as, for example, calendar quarters, milliseconds, microseconds, or nanoseconds.

It will be appreciated that the pre-defined buckets may be managed in any time zones (e.g. UTC). It will be further appreciated that any requests for events based on the time zone matching the pre-defined bucket will results in at most one single fetch of data, thereby allowing for fast retrieval of information. It will also be appreciated that the ceiling of the number of requests based on the pre-defined time buckets as set forth above, will result in at most eighty-six (86) fetches of data from the data tier 280; resulting in fast retrieval of large volumes of data.

In at least one embodiment of the present disclosure, the method 300 then proceeds to step 320 where goals are evaluated via the goal evaluator 272. As disclosed above, the SaaS supplier 202 and SaaS buyer 206 may have certain business goals (e.g. supplier desired outcomes 202B and buyer desired outcomes 206A, respectively) that they each desire to have accomplished. In at least one embodiment of the present disclosure, the shared CRM 250 is configured to evaluate whether such business goals are accomplished upon the occurrence of each processed event.

In at least one embodiment of the present disclosure, business goals (e.g. supplier desired outcomes 202B and buyer desired outcomes 206A, respectively) are configurable based on the business relationship of each of the entities (i.e. SaaS supplier 202 and SaaS buyer 206). It will be appreciated that the state of each business goals is tracked by the goal evaluator 272. By way of an example, a goal can be considered as ‘being achieved’ or ‘not being achieved.’ For example, SaaS buyer 206 may desire that its employees use and adoption of the SaaS product 202A is 90% throughout SaaS buyer 206's organization. If the goal evaluator 272 determines that use and adoption rate is over 90%, the goal evaluator 272 then indicates that the goal desired outcomes is ‘being accomplished.’ Conversely, if there is a change in the adoption and usage rate of the SaaS product 202A leading to a dip below the 90% desired outcome, the goal evaluator 272 is configured to change the state to ‘not being accomplished.’

In at least one embodiment of the present disclosure, the metrics used to determine the state of desired outcomes are derived from any combination of the following: output from data silos; output from machine learning systems; output from analytics; and output from data scientists.

It will be appreciated that goals are configurable based on criteria (e.g. from SaaS supplier 202 or SaaS buyer 206).

In at least one embodiment of the present disclosure, the method 300 is configured to propagate changes at step 322 via the subscription worker 274. For example, referring to FIG. 2C, the subscription worker 274 is configured to receive updates based on processed events. The subscription worker 274 is configured to queue the processed events in workers to split the work, add the work to the queues (e.g. 278A) and transmit the events to the gateways (e.g. 280A). It will be appreciated that the subscription worker 274 is configured to use subscription list 284 to only determine which events are relevant to data that is currently being viewed on scree (e.g. via device 282A, 282B, or 282C). In at least one embodiment of the present disclosure, the subscription list 284 includes information about what processed events must be transmitted, and to which end device (e.g. 282A, 282B, or 282C) it must be transmitted to.

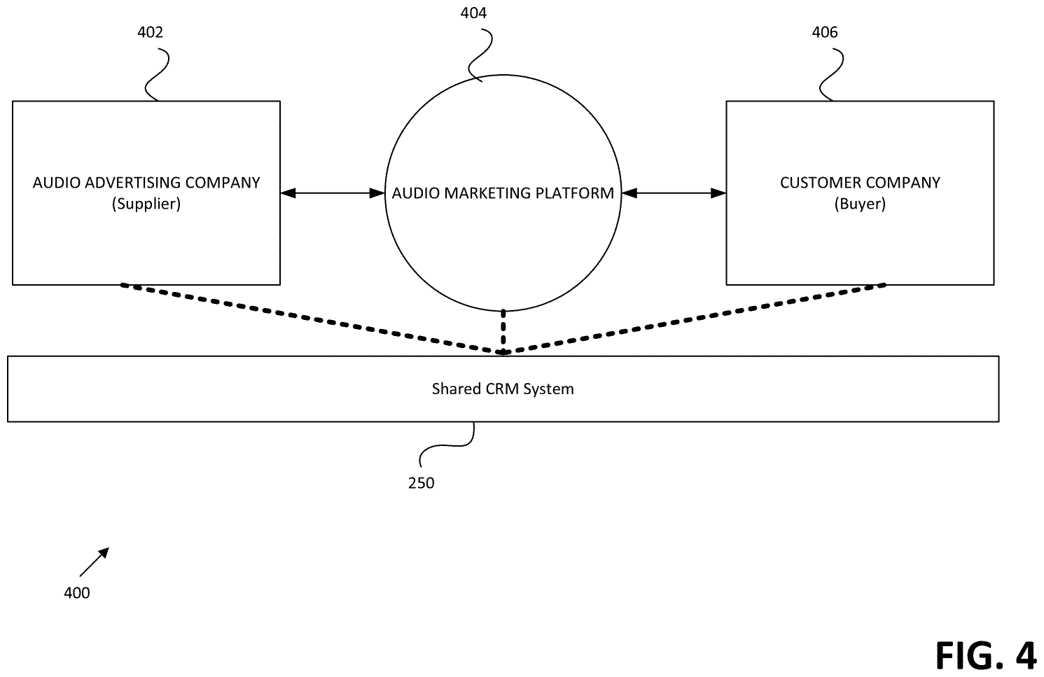

Referring now to FIG. 4, it is shown an exemplary embodiment of a shared CRM 250 400, in accordance with one embodiment of the present disclosure. The system 400 includes a supplier 402, a SaaS product platform 404, a buyer 406, and shared CRM 250.

In this exemplary embodiment, the supplier 402 operates “AUDIO MARKETING PLATFORM,” an online marketing platform (i.e. platform 404) to facilitate and mange advertising for companies. In at least one embodiment of the present disclosure, the buyer 406 has purchased the use of the platform 404 from supplier 402. In this exemplary embodiment, buyer 406 desires to use platform 404 to facilitate advertising for buyer 406.

Continuing with this example, the system 400 further includes shared CRM 250, that is operably connected and integrated (e.g. via APIs) with the supplier 402, the supplier 402′s platform 404, and the buyer 406, thereby making shared CRM 250 the single point of record for purposes as further disclosed herein.

In at least one embodiment of the present disclosure, the platform 404 is configured to transmit certain event data to shared CRM 250. By way of an example, platform 404 may be configured to transmit all advertising placed by buyer 406 and its employees on platform 404, to shared CRM 250. In at least one embodiment of the present disclosure, the platform 404 may be configured to transmit costs of advertising, identifiers of employees, advertising preferences, and the like, to name a few non-limiting examples. It will be appreciated that the buyer 406 and supplier 402 can mutually agree to the types of events and event data that will be transmitted from platform 404 to shared CRM 250.

In at least one embodiment of the present disclosure, shared CRM 250 is configured to ingest event data from platform 404, in accordance with method 300, as further disclosed herein. It will be appreciated that the event data may be transmitted from platform 404 to shared CRM 250 via APIs or other means well known to one having ordinary skill in the art. It will be further appreciated that event data may also be transmitted from sources other than platform 404. By way of the example above, shared CRM 250 may be configured to receive impression data as event data from a third-party source.

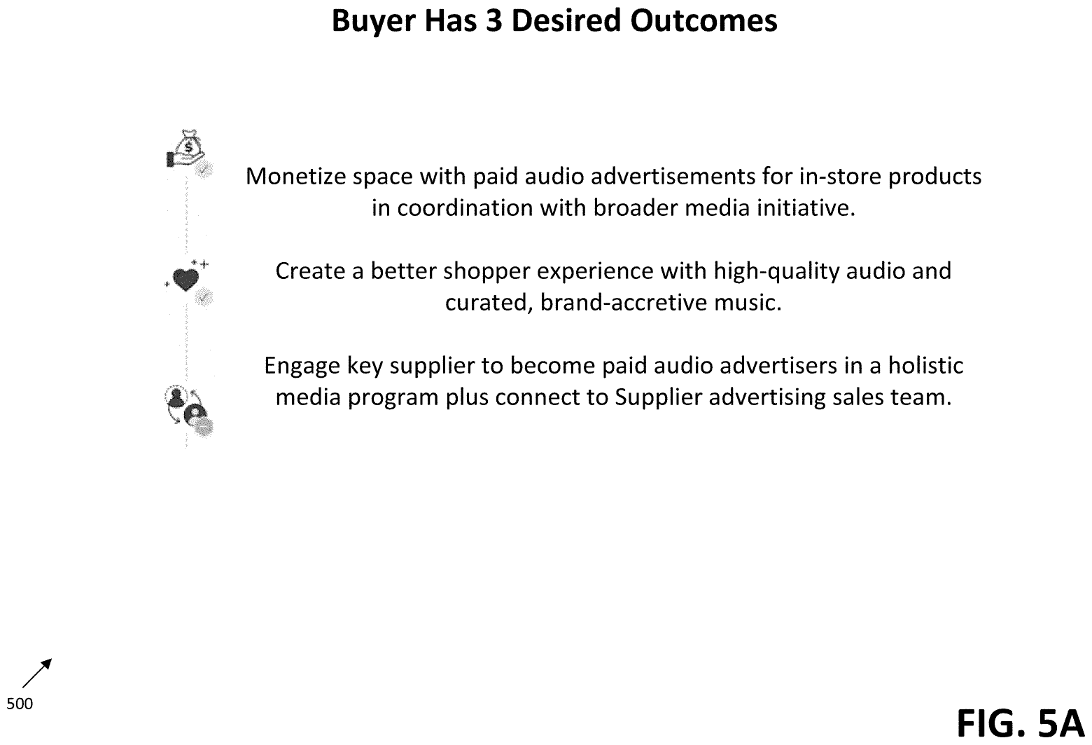

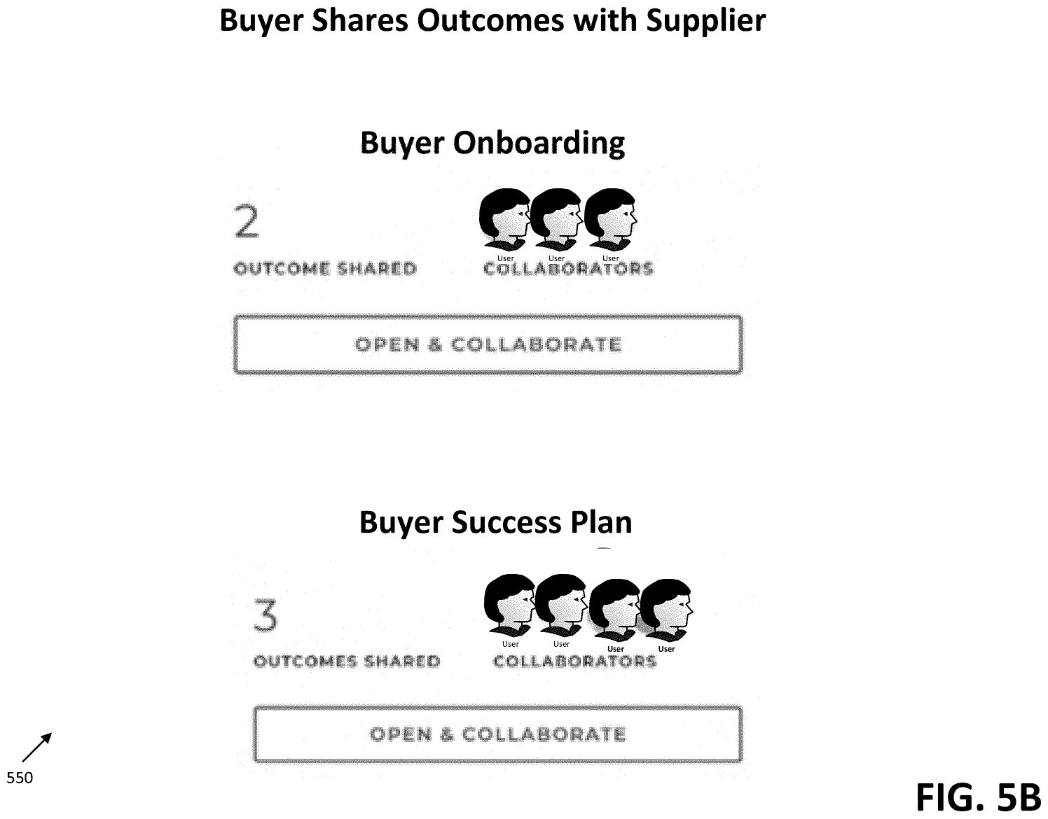

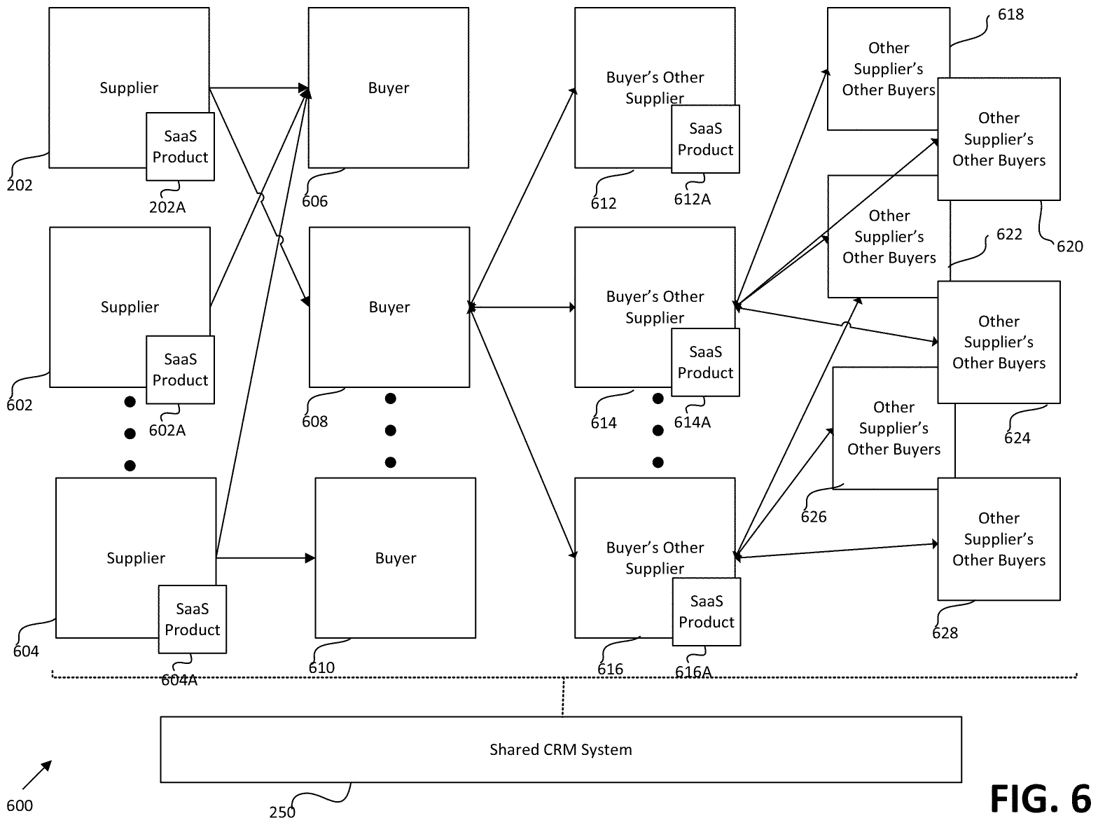

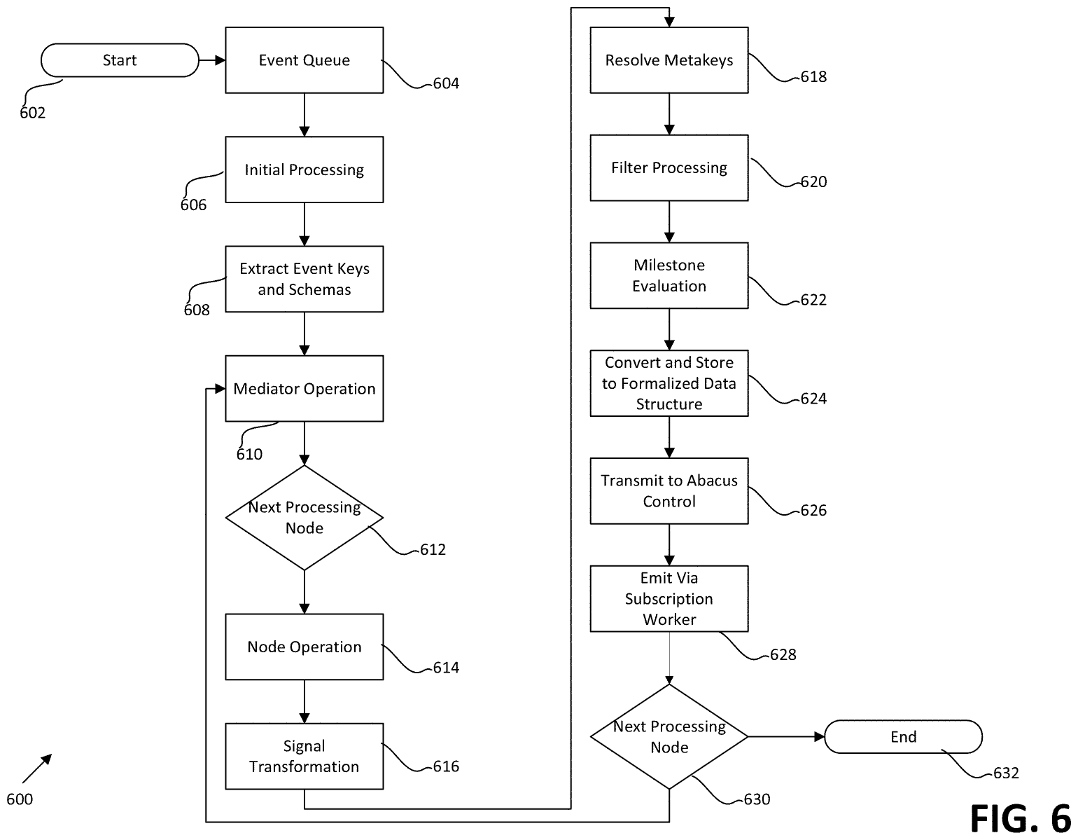

Referring now to FIG. 5A and FIG. 5B, it is shown an exemplary embodiment of milestones in shared CRM 250. Continuing with the example above, supplier 402 and buyer 406 desire to establish determinative outcomes for mutually beneficial milestones. By way of an example, as shown in FIG. 5A, an exemplary outcome is to ensure that buyer 406's can monetize space with paid audio advertisements. In the exemplary embodiment, the supplier 402 has determined that buyer 406's desired outcome is not being met. It will be appreciated that the desired outcome of monetized space with paid audio advertisements is an example of the buyer participating in how it is managed by the supplier 402.

Continuing with the above example, shared CRM 250 is configured to manage multiple outcomes. By way of an example, as shown in FIG. 5B, it is shown the sharing of outcomes. It will be appreciated that each of the outcomes is defined by the buyer 406, enabling buyer 406 to participate in how they are being managed by the supplier 402. It will be further appreciated that by supplier 402 and buyer 406 utilizing shared CRM 250 to track, manage, and interact with each other, supplier 402 and buyer 406 share the same shared CRM 250, allowing information to flow between both supplier 402 and buyer 406, and allowing both parties to have better and measurable outcomes.

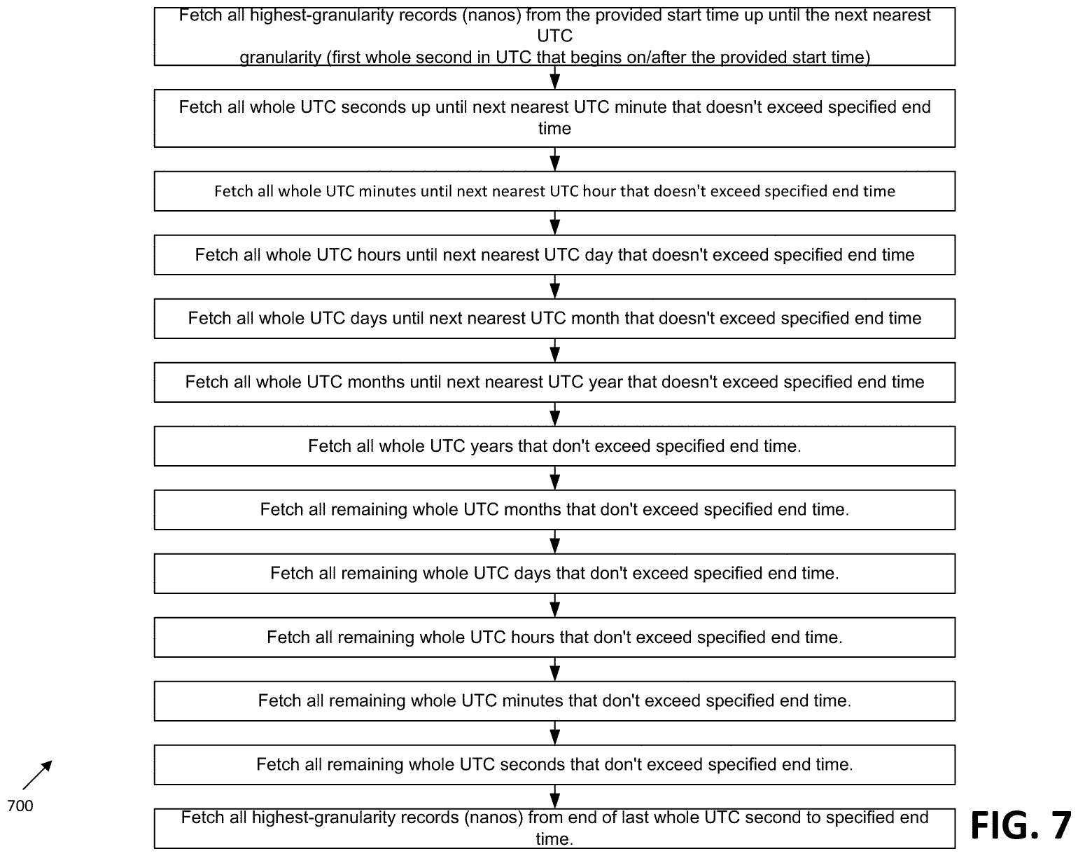

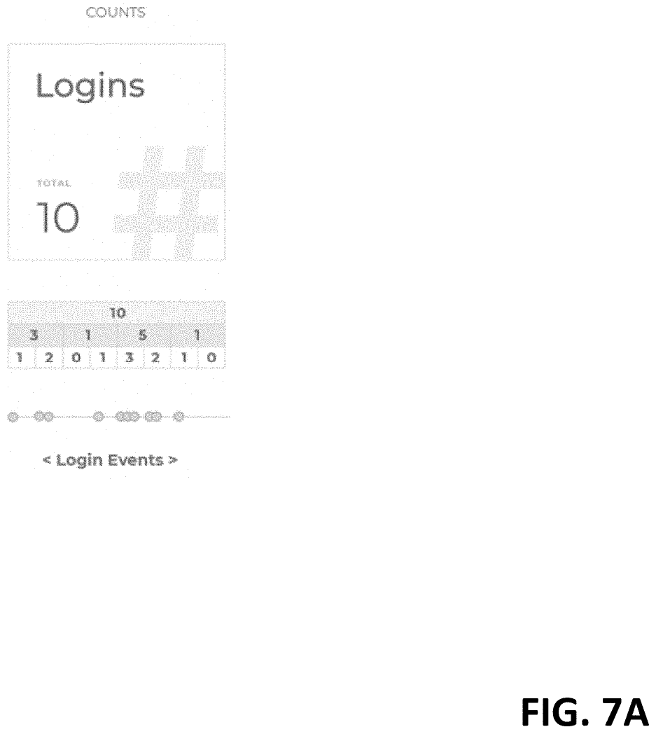

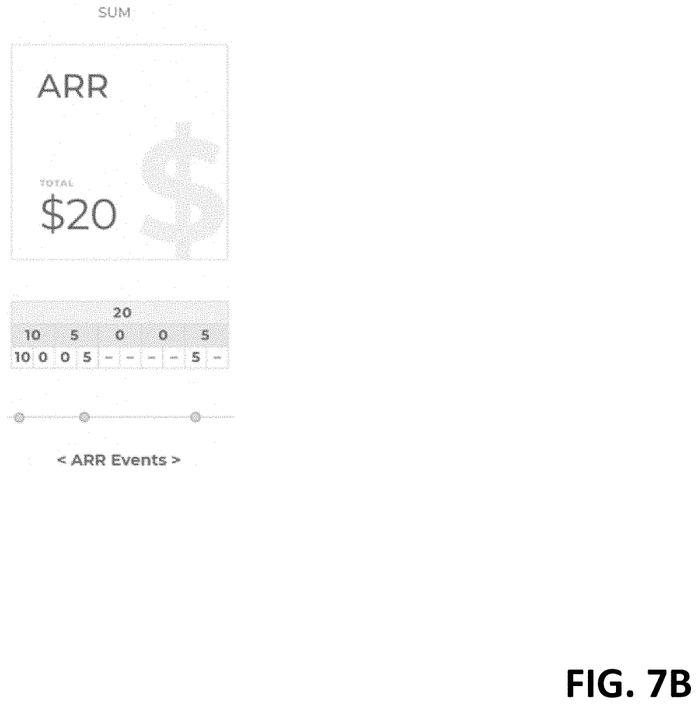

Referring now to FIG. 7, it is shown a method 700 of exemplary time architecture according to at least one embodiment of the present disclosure. In at least one embodiment of the present disclosure, all events, evaluations decisions, object changes, and state changes are maintained at full fidelity and replayable in time, as further disclosed herein; however, users of the shared CRM 250 may desire to see metrics based upon their own locale. It will be appreciated that a locale is a geographic region that honors a specific time zone (offset from Universal Coordinated Time or UTC), optionally shifting daylight savings on specific days of the year. It will be further appreciated that users of the shared CRM 250 expect to see times based on defined boundaries of their time zone/locale.

In at least one embodiment of the present disclosure, the method 700 performs an abstract calculation of provides a mechanism for looking up an arbitrary block of time. It will be appreciated that the method 700 can be used for both milestone evaluations (e.g. at step 320 of method 300), or performing queries for data.

Referring now to FIG. 7A, it is shown an exemplary graphical representation 700 of the time zone architecture of method 700. It will be appreciated that the method 700 yields a minimum number of rows (based on UTC pre-calculated blocks) to be able to recalculate any given timeframe in the desired time zone/locale. It will be further appreciated that the required calculation (sum, average, formula, other) will be abstracted from the selection of input data, and for calculation to reoccur for the returned set of rows.

By way of an example, for a single midnight-to-midnight date range with a fifteen minute offset time zone on a DST shift (i.e. from 00:00+01:15 to 23:59:59+00:15) the query will need to address a daylight savings time shift. Continuing with this example, the query will need to retrieve the following offsets:

+01:15:00 to +01:59:59 in UTC minutes (“day 1 01:15”, “day 1 01:16” . . . “day 1 01:59”); +02:00:00 to +25:59:59 in UTC hours (“day 1 02”, “day 1 03”, “day 1 04” . . . “day 2 00” “day 2 01”); and, +26:00:00 to +26:14:59 in UTC minutes (“day 2 02:00”, “day 2 02:01” . . . “day 2 02:14”).

In at least one embodiment of the present disclosure, the foregoing would potentially return 84 rows to be used in the calculation.

In at least one embodiment of the present disclosure, a request for a particular date range would be indicated based on: (i) granularity (e.g. “days”); (ii) start (UTC epoch milliseconds); (iii) end (UTC epoch milliseconds); and (iv) time zone (e.g. ‘America/New_York’).

It will be appreciated that end time may be defined as either exclusive or inclusive—if exclusive, then it must line up with the start boundary for the next block at the requested granularity; if inclusive, then it must line up with the end boundary for the last block at the requested granularity. It will be further appreciated that the query could be defined by a granularity, start, and count (which could then be used to calculate end).

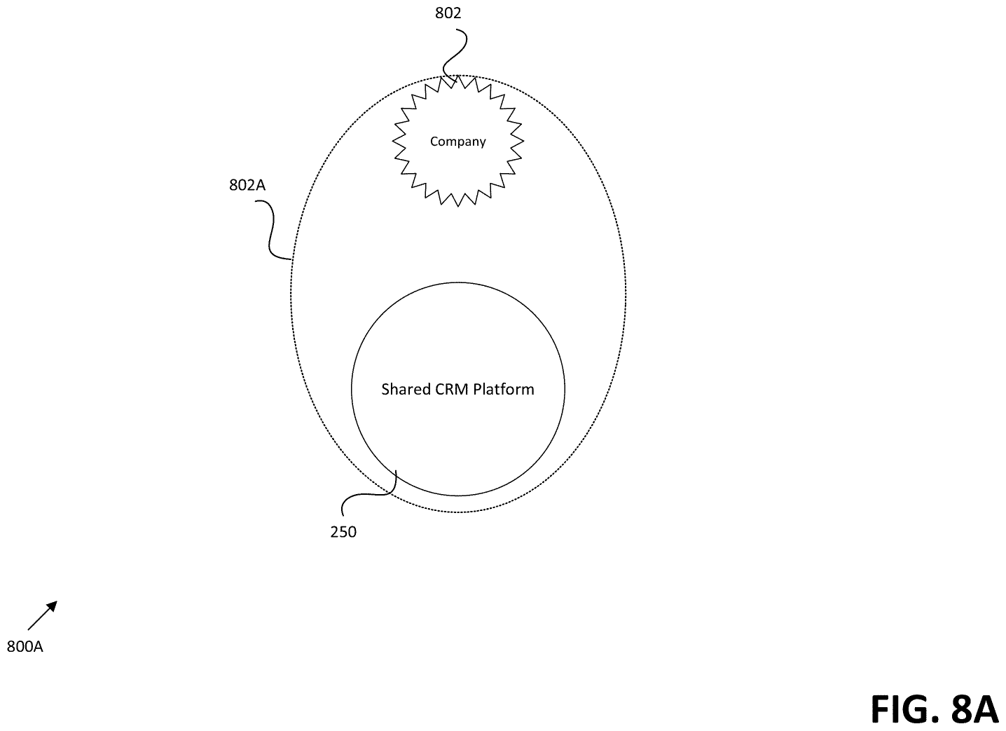

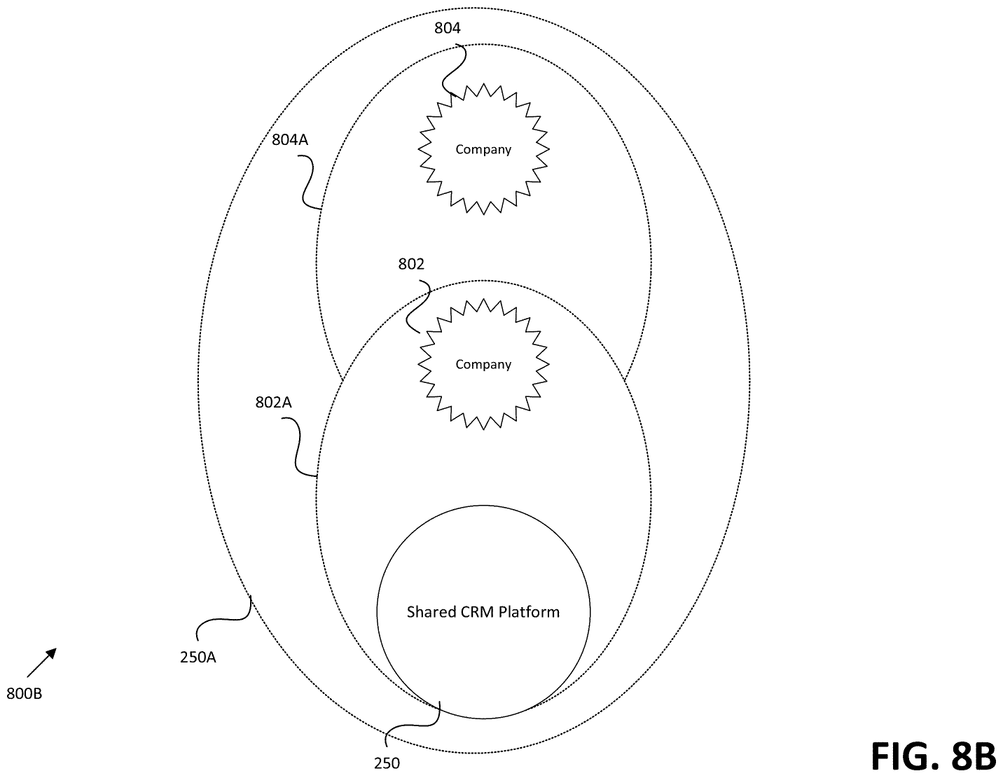

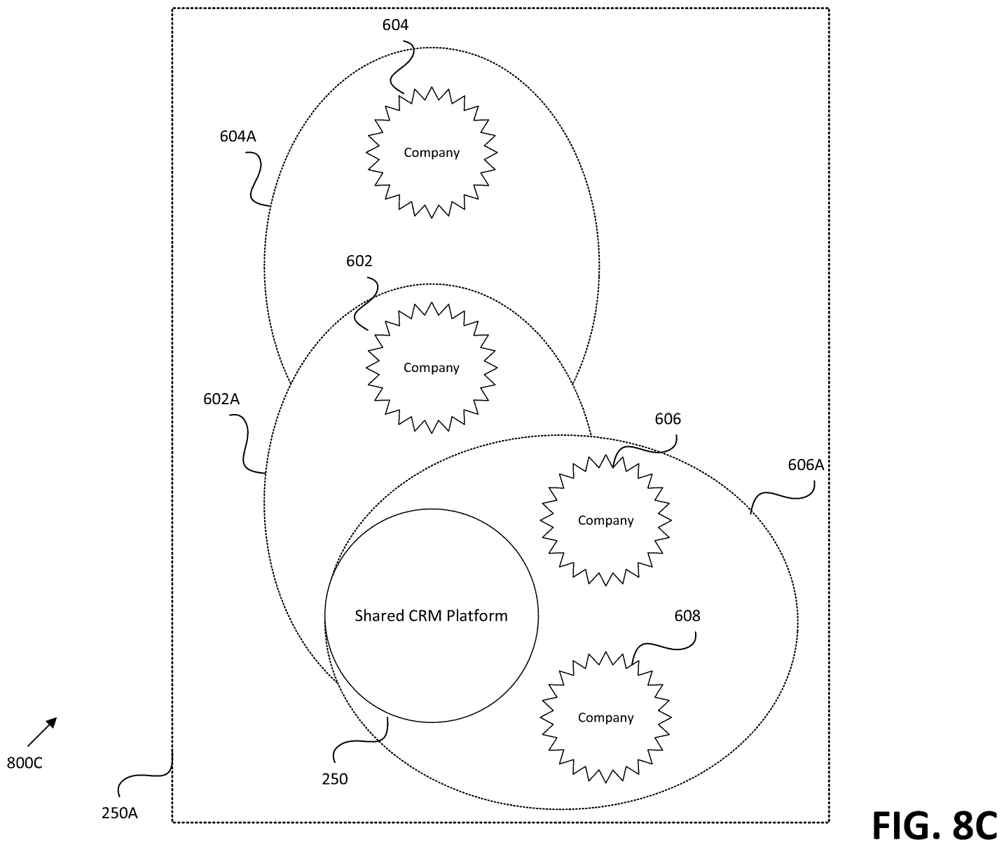

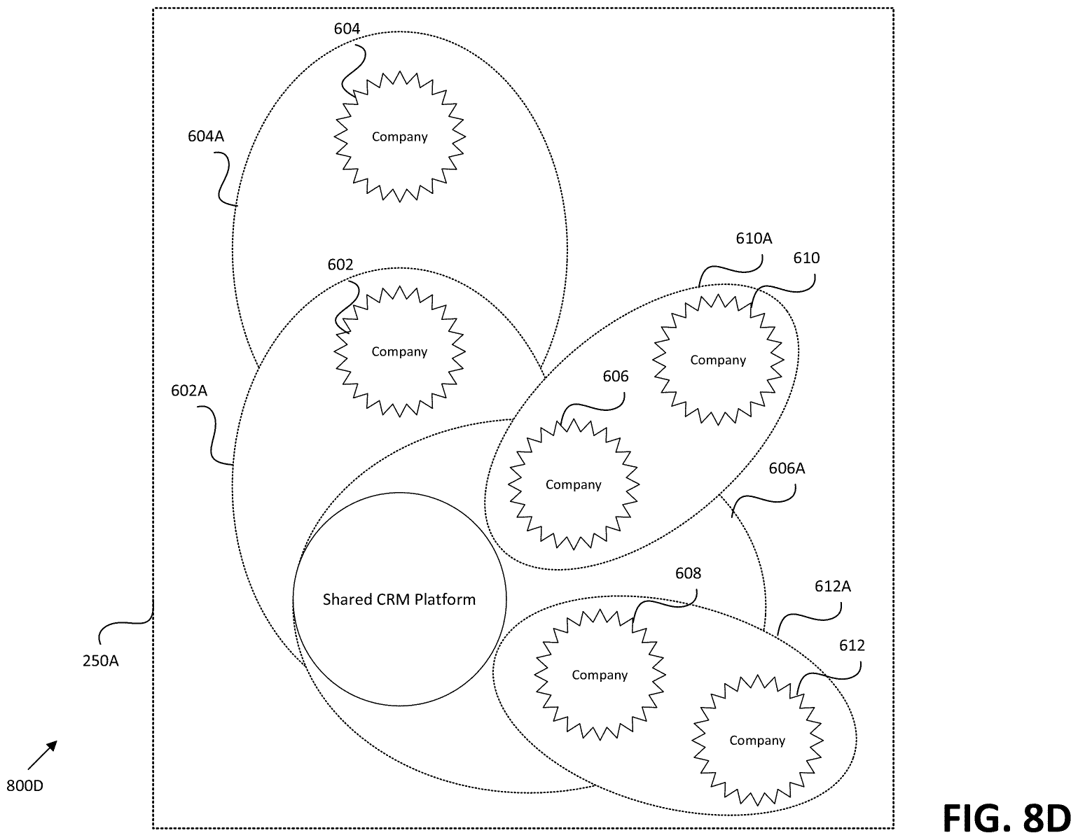

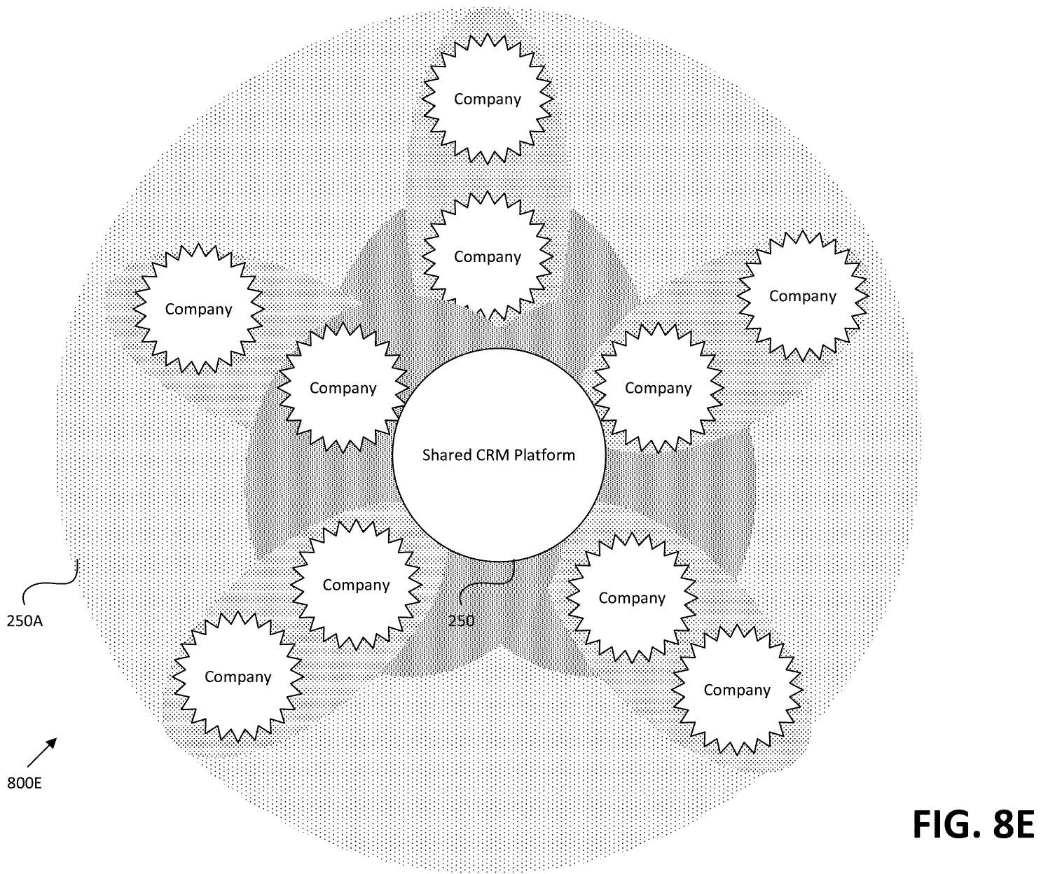

Referring now to FIG. 8A, it is shown a schematic drawing of a business network 600, according to at least one embodiment of the present disclosure. In at least one embodiment of the present disclosure, the business network 800 includes the shared CRM 250, which is operably connected to company 802 as a relationship 802A. In at least one embodiment of the present disclosure, the business network 800 includes a directed acyclic graph.

In at least one embodiment of the present disclosure, the business network 800 can be expanded to include additional stakeholders (i.e. business entities) in relationships. By way of an example, FIG. 8B shows a business network 800B including the shared CRM 250, company 802, and company 804. Company 802 and company 804 are each stakeholders in a relationship 804A with each other. In at least one embodiment of the present disclosure, that company 804 may also interact with shared CRM 250. It will be appreciated that each of the company 802 and company 804 would be stakeholders in the shared CRM 250, as embodied by relationship 250A that encompasses all stakeholders.

Continuing with the example above, the business network 800B can further expand to include additional stakeholders as shown in FIG. 8C, which is an exemplary embodiment business network 800C. In at least one embodiment of the present disclosure, the business network 800C includes additional company 606 and company 608. The each of the company 606 and company 608 are stakeholders to the shared CRM 250 and in relationship 606A to each other. It will be appreciated that the company 606 and company 608 interact through the shared CRM 250.

Continuing with the example above, additional stakeholders can be added, as shown in FIG. 8D.

In at least one embodiment of the present disclosure, the business network can expand to include as many stakeholder entities as desiring to use the shared CRM 250. For example, referring to FIG. 8E, it is shown a business network 800E including a plurality of companies (i.e. business entities), in a plurality of relationships with other companies (i.e. business entities), while commonly sharing the shared CRM 250.

It will be appreciated that shared CRM 250 allows a business or customer (entity) to be both a business and customer. By way of an example, because businesses and customers interact through the shared CRM 250, it is possible that an entity be a customer of a business using the shared CRM and the entity will itself also be a business with customers in the shared CRM. For example, referring to FIG. 2, other buyer 324 could be a buyer of supplier 202 and also a supplier itself. Continuing with this example, it is also possible that each entity can be a customer of one or more businesses in the shared CRM 250 and each entity can have one or more customers in the shared CRM 250. Similarly, referring to FIG. 8D, company 612 may be a customer (e.g. a buyer) of company 608 (e.g. a SaaS provider), and company 608 could also be in the role of a buyer to any other companies in the business network 800D.

In at least one embodiment of the present disclosure, a collection of instances of the shared CRM 250 may operate together as a scalable collection of nodes to form a network used to manage the delivery of goods and services to achieve desired outcomes.

In at least one embodiment of the present disclosure, the core data objects used by one entity can be shared across the network with other related entities (business, customer, or both). It will be appreciated that all events are immutable and kept for all time, allowing for the reproduction of the shared CRM system at any point in time.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. A method for shared customer relationship management (CRM) using event based normalization, the method comprising the steps:
configuring at least one core object for a supplier, a buyer, and a supplier platform;
configuring a plurality of objects representative of a identifier for the each supplier and buyer;
receiving an event data from at least one supplier, buyer, or supplier platform, at an event queue;
normalizing an identity for the each of the supplier, buyer;
normalizing a field name at a field normalizer for the event data;
filtering events based at least in part on a desired outcome of the each of a supplier, a buyer;
creating an object model timeline based on a processed event from the at least one of a supplier, a buyer, or a supplier platform, at an event queue;
updating the at least one core object or plurality of core objects based at least in part on the filtered events;
assessing the desired outcome for the each supplier and buyer, based at least in part on a business goal for the each of the supplier and buyer; and
determining a state for the desired outcome.

2. The method of claim 1, wherein configuring at least one core object for a supplier, a buyer, and a supplier platform comprises a definition of a metric.

3. The method of claim 1, wherein configuring a plurality of objects is selected form a group consisting of a customer, a vendor, a person, a contract, and a desired outcome.

4. The method of claim 1, wherein the event data is received at an event queue and ingested into an immutable log.

5. The method of claim 1, wherein filtering events based at least in part on a desired outcome of the each of a supplier and a buyer comprises determining declarative events, based at least in part on a user defined criteria.

6. The method of claim 1, wherein creating an object model timeline comprises a pre-defined time bucket.

7. The method of claim 1, wherein the business goal for the each of the supplier and buyer are managed by the buyer.

8. The method of claim 1, wherein determining a state for the desired outcome is ongoing and continuous.
